(19) United States
(12) Patent Application Publication
(10) Pub. No.: US 2019/0375147 A1
(43) Pub. Date: Dec. 12, 2019

(54) HOLLOW EXTRUSION-MOLDED BODY, CROSSLINKED BODY THEREOF, HEAT-SHRINKABLE TUBE, AND MULTILAYERED HEAT-SHRINKABLE TUBE

(71) Applicants: SUMITOMO ELECTRIC INDUSTRIES, LTD., Osaka-shi, Osaka (JP); SUMITOMO ELECTRIC FINE POLYMER, INC., Sennan-gun, Osaka (JP)

(72) Inventors: Satoshi YAMASAKI, Osaka-shi, Osaka (JP); Hayato AOI, Sennan-gun, Osaka (JP)

(73) Assignees: SUMITOMO ELECTRIC INDUSTRIES, LTD., Osaka-shi, Osaka (JP); SUMITOMO ELECTRIC FINE POLYMER, INC., Sennan-gun, Osaka (JP)

(21) Appl. No.: 16/481,610

(22) PCT Filed: Oct. 3, 2018
(86) PCT No.: PCT/JP2018/036969

§ 371 Date: Jul. 29, 2019

(30) Foreign Application Priority Data
Nov. 16, 2017 (JP) 2017-220755

(51) Int. Cl. B29C 61/08; B32B 1/08; B32B 27/18; B32B 27/30

(52) U.S. Cl. CPC B29C 61/08; B32B 1/08; C08K 3/22; B32B 27/30; B32B 27/18

(57) ABSTRACT

A hollow extrusion-molded body includes a resin composition that contains a base resin composed of an ethylene-ethyl acrylate copolymer or an ethylene-ethyl acrylate copolymer and a linear low-density polyethylene, a brominated flame retardant, antimony trioxide, and magnesium hydroxide having an average particle size of 0.5 μm to 3.0 μm. In the hollow extrusion-molded body, a composition ratio of the ethylene-ethyl acrylate copolymer to the linear low-density polyethylene, a content of the brominated flame retardant, a content of the antimony trioxide, and a content of the magnesium hydroxide are within specific ranges.

### TECHNICAL FIELD

The present disclosure relates to a hollow extrusion-molded body, a crosslinked body thereof, a heat-shrinkable tube, and a multilayered heat-shrinkable tube. The present application claims priority from Japanese Patent Application No. 2017-220755 filed on Nov. 16, 2017, and the entire contents of the Japanese patent application are incorporated herein by reference.

### BACKGROUND ART

Hollow extrusion-molded bodies are tubular molded bodies obtained by extruding thermoplastic resins. It is disclosed that tubular molded bodies made of thermoplastic resins are used as, for example, insulating coatings of insulated electric wires, coating layers of optical fibers in optical fiber cords, and the like (PTL 1 to PTL 3). Heat-shrinkable tubes are obtained by crosslinking resins that form hollow extrusion-molded bodies and increasing the diameters of the resulting tubes to impart heat shrinkability. Such heat-shrinkable tubes are used as insulating coatings of electric wires and for protection, insulation, waterproofing, corrosion protection, etc. of bundled portions of electric wires and terminals of wiring.

For example, PTL 1 discloses a flame-retardant plastic optical fiber cord obtained by coating a plastic optical fiber bare wire with, as an outer layer of the flame-retardant plastic optical fiber cord, a resin composition that contains 100 parts by weight of a polymer component composed of 20 to 100 parts by weight of an ethylene-vinyl acetate copolymer (EVA) and 80 to 0 parts by weight of a high-pressure radical polymerized long-chain branched low-density ethylene-based polymer, 20 to 60 parts by weight of a brominated flame retardant, 5 to 30 parts by weight of antimony trioxide, and 10 to 80 parts by weight of magnesium hydroxide (claim 1). Here, a plastic optical fiber bare wire is coated with the resin composition by extrusion (paragraph 0015), and the resulting coating is a tubular molded body made of the resin composition.

PTL 2 discloses a flame-retardant insulated electric wire coated with a crosslinked body of a resin composition that contains 15 to 80 parts by mass of a brominated flame retardant, 10 to 70 parts by mass of antimony trioxide, and 10 to 60 parts by mass of magnesium hydroxide treated with a silane coupling agent relative to 100 parts by mass of a resin component containing EVA as a main component. The coating is a tubular molded body formed by coating the periphery of a conductor with the resin composition by extrusion (paragraph 0023).

PTL 3 discloses a heat-resistant crosslinked electric wire produced by coating a periphery of a conductor with a resin composition to form a coating layer, the resin composition containing, as a main component, a resin composed of a high-density polyethylene, a low-density polyethylene, an ethylene-based copolymer, and an ethylene copolymer modified with an unsaturated carboxylic acid anhydride, and a brominated flame retardant and magnesium hydroxide such that the total amount of the brominated flame retardant and the magnesium hydroxide is in the range of 30 to 55 parts by mass relative to 100 parts by mass of the resin, and crosslinking the coating layer. In the formation of the coating layer, the periphery of the conductor is coated with the resin composition using an extruder (paragraph 0027), and a tubular molded body made of the resin composition is formed.

### CITATION LIST

### Patent Literature

PTL 1: Japanese Unexamined Patent Application Publication No. 7-56063

PTL 2: Japanese Unexamined Patent Application Publication No. 2009-51918

PTL 3: Japanese Unexamined Patent Application Publication No. 2014-132530

### SUMMARY OF INVENTION

A first embodiment of the present disclosure is

a hollow extrusion-molded body including a resin composition that contains

a base resin composed of an ethylene-ethyl acrylate copolymer or an ethylene-ethyl acrylate copolymer and a linear low-density polyethylene,

a brominated flame retardant,

antimony trioxide, and

magnesium hydroxide,

in which a composition ratio of the ethylene-ethyl acrylate copolymer to the linear low-density polyethylene is 100:0 to 70:30 (mass ratio),

relative to 100 parts by mass of the base resin,

a content of the brominated flame retardant is 25 parts by mass or more and less than 60 parts by mass,

a content of the antimony trioxide is 10 parts by mass or more and less than 30 parts by mass, and

a content of the magnesium hydroxide is 10 parts by mass or more and less than the content of the brominated flame retardant, and the magnesium hydroxide has an average particle size of 0.5 μm or more and 3.0 μm or less.

A second embodiment of the present disclosure is a crosslinked body of a hollow extrusion-molded body, the crosslinked body being obtained by crosslinking the base resin of the hollow extrusion-molded body according to the first embodiment.

A third embodiment of the present disclosure is a heat-shrinkable tube obtained by increasing a diameter of the crosslinked body of the hollow extrusion-molded body according to the second embodiment.

A fourth embodiment of the present disclosure is a multilayered heat-shrinkable tube including the heat-shrinkable tube according to the third embodiment and an adhesive layer that is disposed on an inner peripheral surface of the heat-shrinkable tube and that contains a hot-melt resin.

### BRIEF DESCRIPTION OF DRAWINGS

FIG. 1 is a perspective view of a heat-shrinkable tube according to a third embodiment of the present disclosure.

FIG. 2 is a perspective view of a multilayered heat-shrinkable tube according to a fourth embodiment of the present disclosure.

FIG. 3 is a sectional view taken along line A-A′ in FIG. 2.

### DESCRIPTION OF EMBODIMENTS

### Problems to be Solved by Present Disclosure

For insulated electric wires used in, for example, electronics/electronic devices/communications, flame retardancy enough to pass the vertical-specimen flame test (VW-1) specified in UL standards may be required. In view of this, hollow extrusion-molded bodies and heat-shrinkable tubes used for forming insulating coatings of such insulated electric wires are also required to have flame retardancy enough to pass the VW-1 flame test. Therefore, a brominated flame retardant, antimony trioxide, and magnesium hydroxide are blended as flame retardants in the resin compositions that form tubular molded bodies described in PTL 1 to PTL 3.

Hollow extrusion-molded bodies and heat-shrinkable tubes used for forming insulating coatings of insulated electric wires are desired to have good mechanical strength such as tensile strength and tensile elongation and thus are often formed by using a resin composition containing EVA as a base, as described in PTL 2. However, the use of the resin composition containing EVA as a base causes problems in that hollow extrusion-molded bodies and heat-shrinkable tubes generate the smell of acetic acid and that heat aging resistance thereof is insufficient.

PTL 3 discloses, as a material that forms an insulating layer, a resin composition containing, as a main component, a resin composed of a high-density polyethylene, a low-density polyethylene, an ethylene-based copolymer, and an ethylene copolymer modified with an unsaturated carboxylic acid anhydride. PTL 3 discloses an ethylene-ethyl acrylate copolymer (EEA) as an example of the ethylene-based copolymer. The use of the resin composition containing EEA as a base can provide good mechanical strength and prevent the problem of generation of the smell of acetic acid.

However, in the case where a hollow extrusion-molded body or a heat-shrinkable tube is produced by extrusion molding, a molten resin is overcome by a pulling force and stretches because there is no support. Therefore, drawdown molding is performed in which a molded body is molded while being positively subjected to drawdown and elongating. However, when drawdown molding is performed by using a resin composition containing EEA as a base, die lip build-up (an adhering substance) is generated around a die nozzle of a molding machine. The die lip build-up may adhere to a tube, which is a molded article, and degrade the appearance of the tube, resulting in a problem of a decrease in the commercial value of the product.

An object of the present disclosure is to provide a hollow extrusion-molded body, a crosslinked body thereof, a heat-shrinkable tube, and a multilayered heat-shrinkable tube that have flame retardancy enough to pass the VW-1 flame test, have good mechanical strength such as tensile strength and tensile elongation, do not have a problem of the smell such as generation of the smell of acetic acid, and do not have problems of generation of die lip build-up and degradation of the appearance of the tube due to drawdown molding.

As a result of studies, the inventor of the present invention has found that a hollow extrusion-molded body obtained by drawdown molding using a resin composition that contains EEA or EEA and a linear low-density polyethylene (LLDPE) as a base resin, where a composition ratio (mass ratio) of the EEA and the LLDPE is in a specific range, and a brominated flame retardant, antimony trioxide, and magnesium hydroxide as flame retardants in specific ranges of a composition ratio (mass ratio) and a heat-shrinkable tube produced from the hollow extrusion-molded body have flame retardancy enough to pass the VW-1 flame test, have good mechanical strength, and do not have a problem of the smell, and that the generation of die lip build-up, which degrades the appearance, is also suppressed during molding of the hollow extrusion-molded body and the heat-shrinkable tube and has completed the present invention.

### Advantageous Effects of Present Disclosure

A hollow extrusion-molded body according to a first embodiment of the present disclosure has flame retardancy enough to pass the VW-1 flame test, does not have a problem of the smell such as generation of the smell of acetic acid, and does not have a problem of degradation of the appearance due to drawdown molding.

A crosslinked body according to a second embodiment and a third heat-shrinkable tube of the present disclosure have flame retardancy enough to pass the VW-1 flame test, have good mechanical strength such as tensile strength and tensile elongation, do not have a problem of the smell such as generation of the smell of acetic acid, and do not have a problem of degradation of the appearance due to drawdown molding.

A multilayered heat-shrinkable tube according to a fourth embodiment of the present disclosure has flame retardancy enough to pass the VW-1 flame test, has good mechanical strength such as tensile strength and tensile elongation, does not have a problem of the smell such as generation of the smell of acetic acid, does not have a problem of degradation of the appearance due to drawdown molding, and has good adhesion to an object to be covered when the multilayered heat-shrinkable tube covers the object to be covered and thermally shrinks.

### Description of Embodiments of the Present Disclosure

Hereinafter, embodiments for carrying out the present disclosure will be specifically described. It is to be understood that the present invention is not limited to the embodiments described below. The present invention encompasses the scope of the claims and all modifications within the meaning and scope equivalent to those of the claims.

A hollow extrusion-molded body according to a first embodiment of the present disclosure is a hollow extrusion-molded body produced by drawdown-molding a resin composition containing a base resin composed of an ethylene-ethyl acrylate copolymer (hereinafter EEA) or EEA and a linear low-density polyethylene (hereinafter LLDPE) and further containing a brominated flame retardant, antimony trioxide, and magnesium hydroxide. In this hollow extrusion-molded body, a composition ratio (mass ratio) of EEA to LLDPE is 100:0 to 70:30, relative to 100 parts by mass of the base resin, the content of the brominated flame retardant is 25 parts by mass or more and less than 60 parts by mass, the content of the antimony trioxide is 10 parts by mass or more and less than 30 parts by mass, and the content of the magnesium hydroxide is 10 parts by mass or more and less than the content of the brominated flame retardant, and the magnesium hydroxide has an average particle size of 0.5 μm or more and 3.0 μm or less.

The base resin of the hollow extrusion-molded body according to the first embodiment is composed of EEA, or is composed of EEA and LLDPE. The base resin does not substantially contain an ethylene-vinyl acetate copolymer (hereinafter EVA). Accordingly, a problem of the smell such as generation of the smell of acetic acid does not occur. In addition, the hollow extrusion-molded body contains a brominated flame retardant, antimony trioxide, and magnesium hydroxide in the ranges described above and has flame retardancy enough to pass the VW-1 flame test.

When EEA serving as a base resin, and a brominated flame retardant, antimony trioxide, and magnesium hydroxide serving as flame retardants are blended and the resulting resin composition is subjected to drawdown molding, there is a problem in that die lip build-up is generated, and the appearance of the resulting tube degrades. However, in the hollow extrusion-molded body according to the first embodiment, the composition ratio of EEA and LLDPE is in a specific range, the amounts of the brominated flame retardant, antimony trioxide, and magnesium hydroxide blended are in specific ranges, and magnesium hydroxide having an average particle size in a specific range is used, thereby suppressing the problem of degradation of the appearance of the tube due to the generation of die lip build-up.

### (Base Resin)

A base resin constitutes a resin component of the resin composition. The resin component may contain the base resin alone and contains the base resin as the maximum component. However, the resin component may contain another resin within a range that does not impair the object of the present invention.

The EEA constituting the base resin is a copolymer of ethylene and ethyl acrylate. The range of the copolymerization ratio of ethylene and ethyl acrylate is not particularly limited. Typically, an EEA having a mass ratio of ethyl acrylate of about 5% to 25% in all the constituent monomers is used. An increase in the ratio of ethyl acrylate decreases the melting point. An EEA having a melting point of 83° C. to 107° C. is typically used.

The range of the molecular weight and the range of the density (specific gravity) of the EEA are also not particularly limited. Typically, an EEA having a melt flow rate (MFR) of 0.3 g/10 min to 25 g/10 min as measured at 190° C. at a load of 21.6 kg and having a specific gravity of 0.92 to 0.95 is used.

The LLDPE constituting the base resin is typically a thermoplastic resin obtained by copolymerizing ethylene that forms a repeating unit with a slight amount of an α-olefin, and the specific gravity of the LLDPE is in a range of about 0.910 to 0.925 (JIS K6899-1:2000). An LLDPE having a short-chain branching (SCB) of about 10 to 30 relative to an ethylene monomer of 1000 is typically used. Examples of the α-olefin copolymerized with ethylene include 1-butene, 1-hexene, 4-methylpentene-1, and 1-octene. The molecular weight of the LLDPE, the type of the α-olefin, the copolymerization ratio, the number of SCB, etc. are not particularly limited.

The composition ratio of EEA in the base resin is 70% by mass or more relative to the total mass of the EEA and the LLDPE. The base resin may contain EEA alone without containing LLDPE. When the composition ratio of the EEA is less than 70% by mass (when the composition ratio of the LLDPE exceeds 30% by mass), die lip build-up is generated during drawdown molding, resulting in degradation of the appearance of the resulting tube.

### (Brominated Flame Retardant)

The brominated flame retardant refers to a brominated aromatic, aliphatic, araliphatic, alicyclic compound, or the like.

Examples of the brominated flame retardant include decabromodiphenyl ether, hexabromobenzene, ethylenebis-tetrabromophthalimide, 2,2-bis(4-bromoethyl ether-3,5-dibromophenyl)propane, ethylenebis-dibromonorbornane dicarboximide, tetrabromobisphenol S, tris(2,3-dibromopropyl-1) isocyanurate, hexabromocyclododecane (HBCD), octabromophnyl ether, tetrabromobisphenol A (TBA) epoxy oligomers or polymers, TBA-bis(2,3-dibromopropyl ether), polydibromophenylene oxide, bis(tribromophenoxy)ethane, ethylenebis-pentabromobenzene, dibromoethyl-dibromocyclohexane, dibromoneopentyl glycol, tribromophenol, tribromophenol allyl ether, tetradecabromo-diphenoxybenzene, 1,2-bis(2,3,4,5,6-pentabromophenyl)ethane, 2,2-bis(4-hydroxy-3,5-dibromophenyl)propane, 2,2-bis(4-hydroxyethoxy-3,5-dibromophenyl)propane, pentabromophenol, pentabromotoluene, pentabromodiphenyl oxide, hexabromodiphenyl ether, octabromodiphenyl ether, octabromodiphenyl oxide, dibromoneopentyl glycol tetracarbonate, bis(tribromophenyl)fumaramide, and N-methylhexabromophenylamine. These brominated flame retardants may be used alone or as a mixture of two or more thereof.

Of the brominated flame retardants exemplified above, 1,2-bis(2,3,4,5,6-pentabromophenyl)ethane is preferred.

The content of the brominated flame retardant in the resin composition is 25 parts by mass or more and less than 60 parts by mass relative to 100 parts by mass of the base resin (the total of EEA and LLDPE).

When the content of the brominated flame retardant is 25 parts by mass or more, flame retardancy enough to pass the VW-1 flame test is obtained. On the other hand, when the content of the brominated flame retardant is 60 parts by mass or more, die lip build-up is generated during drawdown molding, and the appearance of the resulting tube degrades. In addition, mechanical strength such as tensile strength and tensile elongation tends to decrease. The content of the brominated flame retardant is preferably 25 parts by mass or more and less than 50 parts by mass relative to 100 parts by mass of the base resin from the viewpoint of further enhancing flame retardancy and more reliably preventing the generation of die lip build-up.

### (Antimony Trioxide)

The content of antimony trioxide blended as a flame-retardant aid in the resin composition is 10 parts by mass or more and less than 30 parts by mass relative to 100 parts by mass of the base resin. When the content of antimony trioxide is 10 parts by mass or more, flame retardancy enough to pass the VW-1 flame test is obtained. On the other hand, when the content of antimony trioxide is 30 parts by mass or more, die lip build-up is generated during drawdown molding, and the appearance of the resulting tube degrades. In addition, mechanical strength such as tensile strength and tensile elongation tends to decrease. The content of antimony trioxide is preferably 10 parts by mass or more and less than 25 parts by mass relative to 100 parts by mass of the base resin from the viewpoint of further enhancing flame retardancy and more reliably preventing the generation of die lip build-up.

### (Magnesium Hydroxide)

Magnesium hydroxide blended in the resin composition has an average particle size in the range of 0.5 μm to 3.0 μm, as determined by particle size distribution measurement by a laser diffraction method. When magnesium hydroxide having an average particle size of less than 0.5 μm is used, agglomeration due to poor dispersion occurs, and the effect is not obtained. On the other hand, when magnesium hydroxide having an average particle size of more than 3.0 μm is used, die lip build-up is generated during drawdown molding, and the appearance of the resulting tube degrades. Note that the average particle size refers to a particle size at 50% cumulative value in a particle size distribution obtained by measuring the particle size by a laser diffraction/scattering method.

The content of magnesium hydroxide is 10 parts by mass or more relative to 100 parts by mass of the base resin and is lower than the content of the brominated flame retardant. When the content of magnesium hydroxide is 10 parts by mass or more, flame retardancy enough to pass the VW-1 flame test is obtained. On the other hand, when the content of magnesium hydroxide is equal to or higher than the content of the brominated flame retardant, die lip build-up is generated during drawdown molding, and the appearance of the resulting tube degrades. In addition, mechanical strength such as tensile strength and tensile elongation tends to decrease. The content of magnesium hydroxide is preferably 10 parts by mass or more and less than 30 parts by mass relative to 100 parts by mass of the base resin from the viewpoint of further enhancing flame retardancy and more reliably preventing the generation of die lip build-up.

### (Nonessential Component)

The resin composition that forms a hollow extrusion-molded body according to the embodiment may optionally contain, in addition to the essential components described above, a resin other than EEA and LLDPE and an additive other than the brominated flame retardant, antimony trioxide, and magnesium hydroxide within a range that does not impair the object of the present invention. Examples of the other additive include antioxidants, copper inhibitors, lubricants, coloring agents, heat stabilizers, and ultraviolet absorbers. For example, when a hollow extrusion-molded body, a crosslinked body thereof, or the like is used as an insulating coating of an insulated electric wire, an antioxidant is preferably added in order to prevent degradation of the insulating coating with time. Examples of the antioxidant include amine antioxidants such as 4,4′-dioctyl⋅diphenylamine, N,N′-diphenyl-p-phenylenediamine, and polymers of 2,2,4-trimethyl-1,2-dihydroquinoline; phenolic antioxidants such as pentaerythrityl-tetrakis(3-(3,5-di-tert-butyl-4-hydroxyphenyl)propionate), octadecyl-3-(3,5-di-tert-butyl-4-hydroxyphenyl)propionate, and 1,3,5-trimethyl-2,4,6-tris(3,5-di-tert-butyl-4-hydroxybenzyl)benzene; and sulfur-containing antioxidants such as bis(2-methyl-4-(3-n-alkylthiopropionyloxy)-5-tert-butylphenyl)sulfide, 2-mercaptobenzimidazole and a zinc salt thereof, and pentaerythritol-tetrakis(3-lauryl-thiopropionate).

### (Method for Producing Hollow Extrusion-Molded Body)

The hollow extrusion-molded body according to the first embodiment can be produced by melt-kneading the above essential components and other components blended as required using a known kneading machine such as a twin-screw extruder, a Bunbury mixer, a kneader, or a roll, and molding the resulting kneaded product using a known extruder from a die (tubing die) having a tubular nozzle (discharge hole of a resin) into a tube. The molding of the tube is typically performed by drawdown molding as described above. Herein, the drawdown molding refers to a molding method in which an extruded molded body is molded while being elongated in an extrusion direction.

A second embodiment of the present disclosure is a crosslinked body of a hollow extrusion-molded body obtained by crosslinking the base resin of the hollow extrusion-molded body according to the first embodiment. Crosslinking of the base resin of the hollow extrusion-molded body can provide a tubular crosslinked body having good mechanical strength such as tensile strength and tensile elongation while maintaining the good properties of the hollow extrusion-molded body. Furthermore, a heat-shrinkable tube according to a third embodiment can be produced by increasing the diameter of the resulting tubular crosslinked body.

### (Crosslinking)

Examples of the method for crosslinking the base resin of the hollow extrusion-molded body include methods such as crosslinking by irradiation with ionizing radiation, chemical crosslinking, and thermal crosslinking. From the viewpoint of, for example, the ease of operation, crosslinking by irradiation with ionizing radiation is preferred. Examples of the ionizing radiation include corpuscular radiation, such as α-rays, β-rays, and electron beams, and high-energy electromagnetic waves such as X-rays and γ-rays. Of these, electron beams are preferably used in view of, for example, controllability and safety.

The radiation dose of the ionizing radiation is not particularly limited. It is preferable to select a radiation dose with which a sufficient crosslinking density is achieved and degradation of the resin due to irradiation is insignificant.

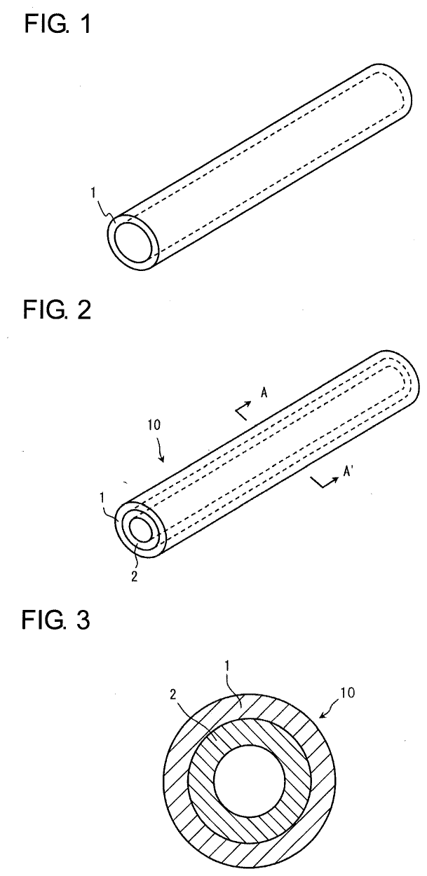

A third embodiment of the present disclosure is a heat-shrinkable tube 1 obtained by increasing the diameter of the crosslinked body of the hollow extrusion-molded body according to the second embodiment, as illustrated in FIG. 1. The heat-shrinkable tube 1 of the third embodiment is a heat-shrinkable tube having good mechanical strength such as ensile strength and tensile elongation while maintaining the good properties of the hollow extrusion-molded body according to the first embodiment.

### (Increase in Diameter)

The heat-shrinkable tube 1 according to the third embodiment is produced by increasing the diameter of the crosslinked body of the hollow extrusion-molded body according to the second embodiment to impart heat shrinkability. The increase in the diameter can be performed by a method including inflating a crosslinked body of the hollow extrusion-molded body (tubular crosslinked body) according to the second embodiment so as to have a predetermined inner diameter in a state where the crosslinked body is heated at a temperature equal to or higher, than a melting point thereof, and subsequently cooling the crosslinked body to fix the shape. The inflation of the tubular crosslinked body can be performed by, for example, a method of introducing compressed air into the inside. The increase in the diameter is typically performed such that the inner diameter is about 1.5 times to 4 times the original inner diameter.

The heat-shrinkable tube 1 according to the third embodiment is used as an insulating coating of an insulated electric wire and for protection, waterproofing, corrosion protection, etc. of a bundled portion of electric wires and a terminal portion of wiring.

A fourth embodiment of the present disclosure is a multilayered heat-shrinkable tube 10 including a heat-shrinkable tube 1 according to the third embodiment and an adhesive layer 2 that is disposed on the inner peripheral surface of the heat-shrinkable tube and that contains a hot-melt resin, as illustrated in FIGS. 2 and 3.

Since the multilayered heat-shrinkable tube 10 includes an outer layer formed of the heat-shrinkable tube 1 according to the third embodiment, the multilayered heat-shrinkable tube 10 has good properties as in the heat-shrinkable tube 1 according to the third embodiment. Furthermore, since the adhesive layer 2 containing a hot-melt resin is formed on the inner peripheral surface of the heat-shrinkable tube, during thermal shrinkage, the adhesive layer flows along the shape of a portion to be covered, and adhesion to the portion thereby improves. Thus, protection, waterproofing, and corrosion protection of the portion can be made more reliable.

### (Method for Producing Multilayered Heat-Shrinkable Tube According to Fourth Embodiment)

The multilayered heat-shrinkable tube can be produced by, for example,

1) a method including molding a hot-melt resin so as to have a tubular shape to prepare a tube, and causing an outer peripheral surface of the tube to adhere to an inner peripheral surface of a heat-shrinkable tube according to the third embodiment prepared as described above,
2) a method including molding a hot-melt resin so as to have a tubular shape to prepare a tube, causing an outer peripheral surface of the tube to adhere to an inner peripheral surface of a crosslinked body of a hollow extrusion-molded body according to the second embodiment prepared as described above, and subsequently increasing the diameter as described above, or
3) a method including extruding (coextruding) a resin composition for forming a hollow extrusion-molded body according to the first embodiment and a hot-melt resin for forming an adhesive layer such that the adhesive layer is disposed on the inside, and subsequently performing crosslinking and increasing the diameter as described above.

### (Hot-Melt Resin)

The hot-melt resin, which is a material for forming the adhesive layer 2, is desirably a resin that has adhesiveness, that can be molded into a tube, that does not deform or flow during storage at room temperature, and that melts and flows at a temperature during thermal shrinkage and can be selected from existing hot-melt resins having these properties. Specifically, EVA, polyamide resins, polyester resins, and the like can be used as the hot-melt resin. Of these, at least one resin selected from the group consisting of EVA and polyamide resins is preferably used because the resin can adhere to various different types of materials such as metals, polyvinyl chloride, and polyethylene, which can serve as an adherend of the heat-shrinkable tube.

In addition to the hot-melt resin, other additives and the like may be optionally blended in the adhesive layer 2 within a range that does not impair the object of the present invention. Examples of the other additives include antioxidants, copper inhibitors, deterioration inhibitors, viscosity improvers, flame retardants, lubricants, coloring agents, heat stabilizers, ultraviolet absorbers, and gluing agents.

### (Use of Multilayered Heat-Shrinkable Tube According to Fourth Embodiment)

Since the multilayered heat-shrinkable tube 10 includes, on the inner peripheral surface thereof, the adhesive layer containing a resin that has adhesiveness and that melts and flows at a temperature during thermal shrinkage, the adhesive layer flows during thermal shrinkage to achieve good adhesion to a covering portion of an object to be covered. Accordingly, the multilayered heat-shrinkable tube is suitably used as an insulating coating of an electric wire and for reliably achieving protection, waterproofing, corrosion protection, etc. of a bundled portion of electric wires and a terminal portion of wiring.

### EXAMPLES

### 1) Materials Used in Experimental Examples

### (EEA)

EEA 1 Amount of EA (ethyl acrylate): 18% by weight, MFR=6, Melting point: 93° C.
EEA 2 Amount of EA: 15% by weight, MFR=0.8, Melting point: 100° C.
EEA 3 Amount of EA: 20% by weight, MFR=5, Melting point: 96° C.

### (LLDPE)

LLDPE 1 MFR=0.7, Density: 0.92 g/mL

### (EVA)

EVA 1 Amount of VA: 17% by weight, MFR=0.8, Melting point: 89° C.

### (Flame Retardant)

Brominated flame retardant
Antimony trioxide
Magnesium hydroxide 1 Average particle size: 0.8 μm, BET specific surface area: 6.0 m²/g, Untreated
Magnesium hydroxide 2 Average particle size: 0.8 μm, BET specific surface area: 6.0 m²/g, Treated with stearic acid
Magnesium hydroxide 3 Average particle size: 1.7 μm, BET specific surface area: 2.7 m²/g, Untreated
Magnesium hydroxide 4 Average particle size: 7.0 μm, BET specific surface area: 35 m²/g, Untreated (Another additive)

In formulations of Experimental Examples 1 to 14, in addition to the above materials, an antioxidant is added in an amount of 4 parts by mass relative to 100 parts by mass of the base resin.

### 2) Production of Electric Wire and Presence or Absence of Substance Adhering to Die Portion

Resin compositions having formulations (parts by mass) shown in Tables 1 to 3 were melt-kneaded using the materials described in 1) above. Each of the resin compositions was then extruded (full-extruded) by using a 50 mm ϕ single-screw extruder from a nozzle of a die at a line speed of 20 m/min to form a coating layer having a wall thickness t of 1 mm on an outer periphery of an electric wire (0.8 tin-plated copper wire). A nozzle portion of the die was visually observed. When no adhering substance (die lip build-up) was observed, the result was evaluated as “not present”. When an adhering substance was observed, the result was evaluated as “present”. The results are shown in the row of “substance adhering to die portion in production of electric wire” in Tables 1 to 3.

### 3) Production of Tube and Presence or Absence of Substance Adhering to Die Portion

Resin compositions having formulations (parts by mass) shown in Tables 1 to 3 were melt-kneaded using the materials described in 1) above. Each of the resin compositions was then drawdown-molded by using a 50 mm ϕ single-screw extruder from a nozzle of a die at a line speed of 20 m/min and at a drawdown ratio of 2.0 to prepare a tube (hollow extrusion-molded body) having an outer diameter ϕ of 8.0 mm, an inner diameter ϕ of 6.0 mm, and a wall thickness t of 1 mm. A nozzle portion of the die was visually observed. When no adhering substance (die lip build-up) was observed, the result was evaluated as “not present”. When an adhering substance was observed, the result was evaluated as “present”. The results are shown in the row of “substance adhering to die portion in production of tube” in Tables 1 to 3. The drawdown ratio is a value determined by [(nozzle diameter)²−(core bar outer diameter)²]/[(tube outer diameter)²−(tube inner diameter)²].

### 4) VW-1 Flame Test

The tube produced in 3) above was irradiated with an electron beam at a dose of 200 kGy to prepare a sample. For five samples prepared in this manner, the VW-1 vertical-specimen flame test described in UL standards was conducted. Specifically, a flame of a burner was applied to each of the samples at an angle of 20 degrees for 15 seconds and then removed for 15 seconds. This procedure was repeated five times. When the flame expired within 60 seconds, surgical cotton laid on a lower portion was not ignited by flaming drops, and a strip of kraft paper attached to an upper portion of the sample did not burn or scorch, the sample was evaluated as acceptable. In the case where all the five samples reached the acceptable level, the samples were evaluated as acceptable. In the case where at least one of the five samples did not reach the acceptable level, the samples were evaluated as unacceptable. The results are shown in Tables 1 to 3.

### 5) Tensile Strength and Tensile Elongation

The tube produced in 3) above was irradiated with an electron beam at a dose of 200 kGy to prepare a sample. The prepared sample was pulled at a rate of 500 mm/min by the method specified in MS C3005 (2014) to measure the tensile strength and the tensile elongation. The measurement results are shown in Tables 1 to 3.

### 6) Smell

The tube produced in 3) above was irradiated with an electron beam at a dose of 200 kGy to prepare a sample. The prepared sample was cut to a length of 5 cm and placed in a test tube. The test tube was covered with a lid and allowed to stand at room temperature for one day. Subsequently, the lid was removed, and the sample was smelled to determine whether an irritating smell was sensed or not. The determination was carried out by different three persons. In the case where at least one of the persons sensed an irritating smell, the sample was evaluated as unacceptable. In the case where none of the persons sensed an irritating smell, the sample was evaluated as acceptable. The results are shown in Tables 1 to 3.

TABLE 1

| | | Experimental | Experimental | Experimental | Experimental | Experimental |
|---|---|---|---|---|---|---|
| | | Example 1 | Example 2 | Example 3 | Example 4 | Example 5 |
| Base resin | EEA1 | 100 | 100 | 100 | — | — |
| | EEA2 | — | — | — | 100 | — |
| | EEA3 | — | — | — | — | 100 |
| | LLDPE1 | — | — | — | — | — |
| | EVA1 | — | — | — | — | — |
| Flame | Brominated flame retardant | 40 | 40 | 40 | 40 | 40 |
| retardant | Antimony trioxide | 20 | 20 | 20 | 20 | 20 |
| | Magnesium hydroxide 1 | 30 | — | — | 30 | 30 |
| | Magnesium hydroxide 2 | — | 30 | — | — | — |
| | Magnesium hydroxide 3 | — | — | 30 | — | — |
| | Magnesium hydroxide 4 | — | — | — | — | — |
| Evaluation | Substance adhering to die | Not present | Not present | Not present | Not present | Not present |
| results | portion in production of | | | | | |
| | electric wire | | | | | |
| | Substance adhering to die | Not present | Not present | Not present | Not present | Not present |
| | portion in production of tube | | | | | |
| | VW-1 flame test | Acceptable | Acceptable | Acceptable | Acceptable | Acceptable |
| | Tensile strength (MPa) | 12.5 | 11.8 | 11.2 | 14.3 | 11.8 |
| | Tensile elongation (%) | 460 | 490 | 420 | 430 | 470 |
| | Smell | Acceptable | Acceptable | Acceptable | Acceptable | Acceptable |

TABLE 2

| | | Experimental | Experimental | Experimental | Experimental | Experimental |
|---|---|---|---|---|---|---|
| | | Example 6 | Example 7 | Example 8 | Example 9 | Example 10 |
| Base resin | EEA1 | 70 | 100 | 100 | — | 40 |
| | EEA2 | — | — | — | — | — |
| | EEA3 | — | — | — | — | — |
| | LLDPE1 | 30 | — | — | — | 60 |
| | EVA1 | — | — | — | 100 | 0 |
| Flame | Brominated flame retardant | 40 | 25 | 50 | 40 | 40 |
| retardant | Antimony trioxide | 20 | 10 | 25 | 20 | 20 |
| | Magnesium hydroxide 1 | 30 | 20 | 30 | 30 | 30 |
| | Magnesium hydroxide 2 | — | — | — | — | — |
| | Magnesium hydroxide 3 | — | — | — | — | — |
| | Magnesium hydroxide 4 | — | — | — | — | — |
| Evaluation | Substance adhering to die | Not present | Not present | Not present | Not present | Not present |
| results | portion in production of | | | | | |
| | electric wire | | | | | |
| | Substance adhering to die | Not present | Not present | Not present | Not present | Present |
| | portion in production of tube | | | | | |
| | VW-1 flame test | Acceptable | Acceptable | Acceptable | Acceptable | Acceptable |
| | Tensile strength (MPa) | 13.8 | 14.5 | 11.2 | 10.8 | 13.5 |
| | Tensile elongation (%) | 410 | 520 | 370 | 550 | 380 |
| | Smell | Acceptable | Acceptable | Acceptable | Unacceptable | Acceptable |

TABLE 3

| | | Experimental | Experimental | Experimental | Experimental |
|---|---|---|---|---|---|
| | | Example 11 | Example 12 | Example 13 | Example 14 |
| Base resin | EEA1 | 100 | 100 | 100 | 100 |
| | EEA2 | — | — | | — |
| | EEA3 | — | — | — | — |
| | LLDPE1 | — | — | — | — |
| | EVA1 | — | — | — | — |
| Flame | Brominated flame retardant | 40 | 40 | 60 | 40 |
| retardant | Antimony trioxide | 20 | 20 | 30 | 20 |
| | Magnesium hydroxide 1 | — | 60 | 30 | |
| | Magnesium hydroxide 2 | — | — | — | — |
| | Magnesium hydroxide 3 | — | — | — | — |
| | Magnesium hydroxide 4 | — | — | — | 30 |
| Evaluation | Substance adhering to die | Not present | Not present | Not present | Not present |
| results | portion in production of | | | | |
| | electric wire | | | | |
| | Substance adhering to die | Present | Present | Present | Present |
| | portion in production of tube | | | | |
| | VW-1 flame test | Acceptable | Unacceptable | Acceptable | Acceptable |
| | Tensile strength (MPa) | 12.9 | 10.7 | 9.8 | 10.8 |
| | Tensile elongation (%) | 520 | 330 | 280 | 460 |
| | Smell | Acceptable | Acceptable | Acceptable | Acceptable |

As shown in Tables 1 to 3, when resin compositions are used in which a composition ratio (mass) of EEA to LLDPE is in the range of 100:0 to 70:30, relative to 100 parts by mass of the total of EEA and LLDPE, the content of the brominated flame retardant is 25 parts by mass or more and less than 60 parts by mass, the content of antimony trioxide is 10 parts by mass or more and less than 30 parts by mass, and the content of magnesium hydroxide is 10 parts by mass or more and less than the content of the brominated flame retardant, and the magnesium hydroxide has an average particle size in the range of 0.5 μm to 3.0 μm, die lip build-up is not generated in each of full molding and drawdown molding, and crosslinked bodies of the drawdown molded articles (hollow extrusion-molded bodies of the present disclosure) have flame retardancy enough to pass the VW-1 flame test, have sufficient tensile strength and tensile elongation, and do not have the problem of the smell, such as the smell of acetic acid.

In Experimental Example 9, in which EVA was used instead of EEA or EEA and LLDPE, the smell of acetic acid was sensed, and the problem of the smell occurred.

Furthermore, in Experimental Example 10, in which the amount of EEA was 40% by mass (a case where the amount of EEA was less than 70% by mass) of the total amount of EEA and LLDPE,

in Experimental Example 11, in which magnesium hydroxide was not blended (a case where the content of magnesium hydroxide was less than 10 parts by mass),

in Experimental Example 12, in which the content of magnesium hydroxide was 60 parts by mass (a case where the content of magnesium hydroxide exceeded 40 parts by mass, which was the content of the brominated flame retardant),

in Experimental Example 13, in which the content of the brominated flame retardant was 60 parts by mass (not less than 60 parts by mass), and the content of antimony trioxide was 30 parts by mass (not less than 30 parts by mass) and which had a high proportion of the flame retardants, and

in Experimental Example 14, in which magnesium hydroxide having an average particle size of 7.0 μm was used (a case where the average particle size exceeded 3.0 μm),

die lip build-up was generated in the drawdown molding, as shown in the results of the row of “substance adhering to die portion in production of tube”.

In addition, in Experimental Example 12, which corresponds to a case where the content of magnesium hydroxide exceeded the content of the brominated flame retardant, flame retardancy enough to pass the VW-1 flame test was not also obtained.

When full molding was performed, no die lip build-up was generated in each of Experimental Examples 1 to 14, as shown in the results of the row of “substance adhering to die portion in production of electric wire”.

### REFERENCE SIGNS LIST

1 heat-shrinkable tube
2 adhesive layer
10 multilayered heat-shrinkable tube

1. A hollow extrusion-molded body comprising a resin composition that contains
a base resin composed of an ethylene-ethyl acrylate copolymer or an ethylene-ethyl acrylate copolymer and a linear low-density polyethylene,
a brominated flame retardant,
antimony trioxide, and
magnesium hydroxide,
wherein a composition ratio of the ethylene-ethyl acrylate copolymer to the linear low-density polyethylene is 100:0 to 70:30 (mass ratio),
relative to 100 parts by mass of the base resin,
a content of the brominated flame retardant is 25 parts by mass or more and less than 60 parts by mass,
a content of the antimony trioxide is 10 parts by mass or more and less than 30 parts by mass, and
a content of the magnesium hydroxide is 10 parts by mass or more and less than the content of the brominated flame retardant, and the magnesium hydroxide has an average particle size of 0.5 μm or more and 3.0 μm or less.

2. A crosslinked body of a hollow extrusion-molded body, the crosslinked body being obtained by crosslinking the base resin of the hollow extrusion-molded body according to claim 1.

3. A heat-shrinkable tube obtained by increasing a diameter of the crosslinked body of the hollow extrusion-molded body according to claim 2.

4. A multilayered heat-shrinkable tube comprising the heat-shrinkable tube according to claim 3 and an adhesive layer that is disposed on an inner peripheral surface of the heat-shrinkable tube and that contains a hot-melt resin.

5. The multilayered heat-shrinkable tube according to claim 4, wherein the hot-melt resin is at least one of an ethylene-vinyl acetate copolymer or a polyamide resin.
